(19) United States
(12) Patent Application Publication
(10) Pub. No.: US 2002/0052233 A1
(43) Pub. Date: May 2, 2002

(54) Gaming machine displaying combinations of symbols including special symbols

(76) Inventor: Michael Gauselmann, Espelkamp (DE)

Correspondence Address: Brian D. Ogonowsky, SKJERVEN MORRILL MacPHERSON LLP, Suite 700, 25 Metro Drive, San Jose, CA, 95110-1349, US

(21) Appl. No.: 10/022,460

(22) Filed: Dec. 14, 2001

Related U.S. Application Data
(63) Continuation-in-part of application No. 09/952,613, filed on Sep. 13, 2001.

(30) Foreign Application Priority Data
Sep. 14, 2000 (DE) 100 45 572.7

(51) Int. Cl. A63F 13/00

(52) U.S. Cl. 463/20

(57) ABSTRACT

A random combination of symbols in a matrix is initially displayed in a game. There are one or more specially marked symbols, such as a wildcard symbol, that may be randomly displayed. Upon the display of the one of the specially marked symbols, certain other symbols in the matrix are changed to increase the player's chances of a winning symbol combination across a pay line. The selected symbols may be changed to specially marked symbols or other symbols. Various examples of which symbols are changed in response to the occurrence of a specially marked symbol are described.

### CROSS-REFERENCE TO RELATED APPLICATIONS

This is a continuation-in-part of U.S. application Ser. No. 09/952,613, filed Sep. 13, 2001, incorporated herein by reference.

### FIELD OF THE INVENTION

This invention relates to gaming machines that display a random combination of symbols arranged in rows and columns.

### BACKGROUND

In the April 1984 German journal “Münzautomat,” page 12, a coin operated gaming machine with three reels for displaying symbols is described. When three matching symbols are displayed, an award is paid to the player. A specially marked symbol, for example, a joker, may also be displayed, where the specially marked symbol represents any symbol to create a winning combination. One disadvantage of this type of machine is that there is only one specially marked symbol, and it is on the middle reel of the gaming machine.

The present invention improves on gaming machines of this type having a specially marked symbol that is used to represent other symbols.

### SUMMARY

Various embodiments of games that may be performed on a video gaming device are described herein. In the various embodiments, a random (actually pseudo random) combination of symbols in a matrix is initially displayed, or otherwise initially selected, in the game. There are one or more specially marked symbols (for example, a joker symbol) that may be randomly displayed. Upon the display of the one of the specially marked symbols, other displayed symbols in the matrix are changed to increase the player's chances of a winning symbol combination across a pay line. The selected symbols may be changed to specially marked symbols or other symbols. The specially marked symbols may represent a wild card symbol.

Various examples of which symbols are changed in response to the occurrence of a specially marked symbol are described. In one embodiment, the gaming apparatus is a gaming machine having a CRT display, where selected symbols are changed in accordance with a program run on a microprocessor.

### BRIEF DESCRIPTION OF THE DRAWINGS

FIG. 1 is a perspective view of a gaming device that can display a matrix of a random set of symbols and change selected ones of the symbols due to the occurrence of a specially marked symbol.

FIG. 2 illustrates an initial display and also a final display of a combination of symbols in an array of three rows and five columns, where the asterisk represents a specially marked symbol whose appearance causes adjacent symbols in the initial display to change (in appearance and/or function) in accordance with a program.

FIG. 3 illustrates an initial display and also a final display showing how a specially marked symbol changes other symbols (in appearance and/or function) along a pay line to match the initial symbol at the left end of the horizontal pay line.

FIG. 4 illustrates an initial display and also a final display showing how a specially marked symbol changes symbols (in appearance and/or function) in a pay line to match a symbol at both ends of a bent pay line.

FIG. 5 illustrates an initial display and also a final display showing how a specially marked symbol changes symbols (in appearance and/or function) in a pay line to match a symbol at both ends of a bent pay line.

FIG. 6 illustrates how the occurrence of a specially marked symbol causes a processor to randomly choose symbol locations to convert to other specially marked symbols.

FIG. 7 illustrates various functional circuit blocks in a gaming device.

### DETAILED DESCRIPTION

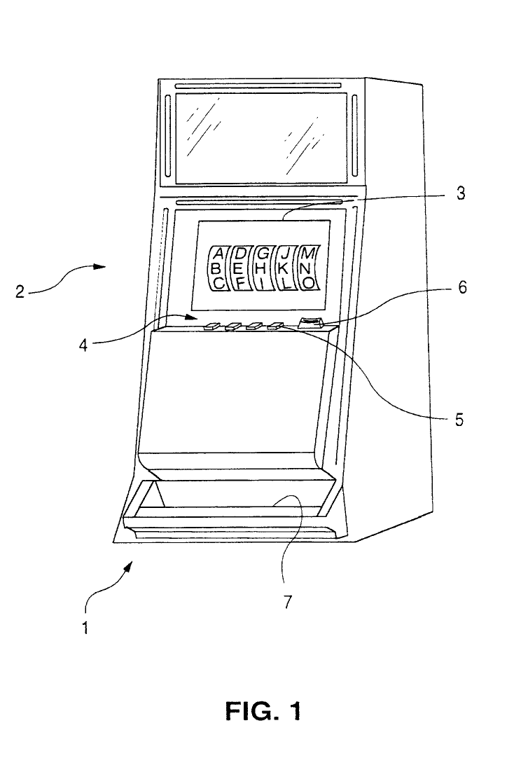

FIG. 1 is but one of the many examples of devices, such as slot machines, that may display a random (more specifically, pseudo random) combination of symbols selected by a processor running a program. This conventional aspects of the embodiments are well known and need not be described in detail. Such conventional aspects may be those described in U.S. Pat. Nos. 6,190,255 and 6,089,976, incorporated herein by reference. FIG. 1 illustrates a stand-alone gaming machine 1 having a front 2 with a display window 3. A video monitor behind display window 3 displays, in one embodiment, five virtual reels, where three adjacent symbols on each reel are displayed through window 3.

A control panel 4 beneath display 3 has various well-known controls to allow the player to operate the machine 1 using various control elements 5 (e.g., buttons). Also shown in is a coin acceptor 6 and a coin tray 7.

Control circuitry, including a microcomputer (a microprocessor), controls the display and sequence of the gaming machine 1. When a game is played, the control device initiates a pseudo random number generator to identify certain symbol combinations to be displayed. The virtual reels are then spun and stopped in a way such that the predetermined symbol combination is shown. In the embodiment of FIG. 1, the matrix consists of five columns and three rows of symbols. Nine pay lines are evaluated, including straight lines and non-straight lines, provided in examples below. Other forms of gaming devices may be used as well.

To determine a win, the symbols across each pay line are determined. If the same symbol occurs five times on the same pay line, the highest winning value for the symbol is paid. If the same symbol is shown in three or four positions along the same pay line, a lower winning value is paid, respectively. Each virtual reel may display 32 or more symbols.

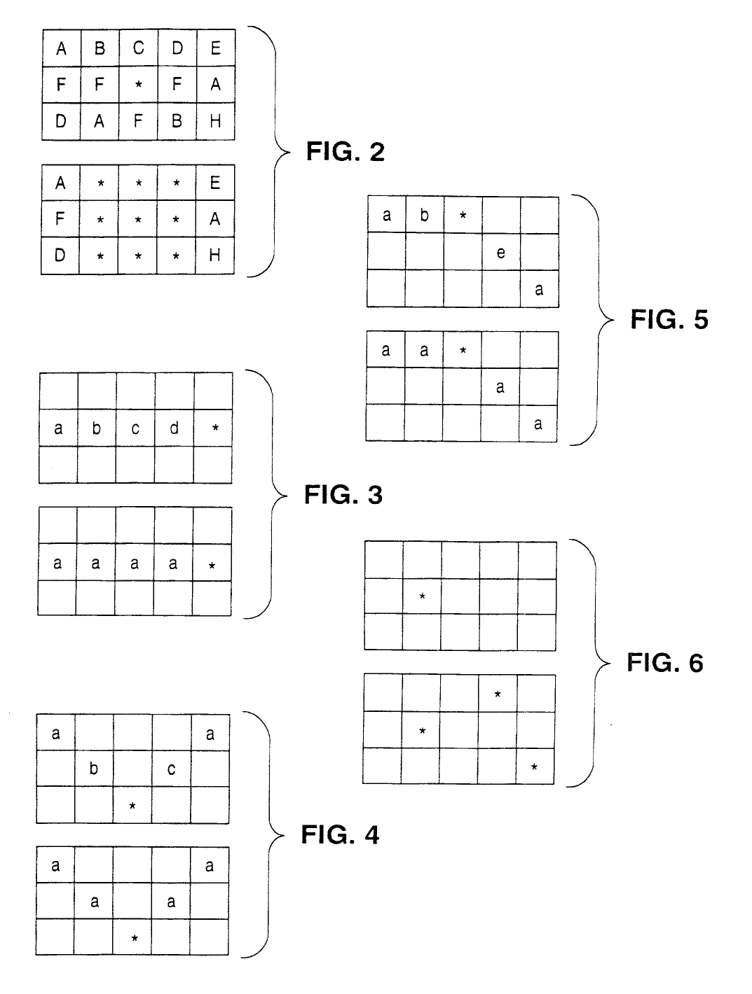

In one embodiment, there is at least one specially marked symbol on each reel. As will be described below, the occurrence of this specially marked symbol has the function of replacing certain displayed symbols with other symbols. The replacing of certain displayed symbols may be implemented by changing the appearance of the initially displayed symbols and/or by changing the function of the initial symbol, such as by changing the function of an “F” symbol to the function of an “A” symbol or a wild card symbol. Various examples of applications of this concept are described below, and selected ones of these concepts are shown in FIGS. 2-6. The specially marked symbol, which can be any type of symbol, is shown for simplicity in the various figures as an asterisk.

### EXAMPLE 1

FIG. 2 illustrates one example of symbols in the initial matrix being changed due to the presence of the specially marked symbol. The virtual reels are started by the control device and stopped at predetermined positions to display the five columns and three rows of symbols in the upper display of FIG. 2. This initial display shows the specially marked symbol occurring in the third column of the third row. As a result, all directly adjacent symbols are treated as wild cards for the evaluation of the winning amount. The arrow from the upper display to the lower display illustrates the effect that the initially displayed specially marked symbol has on the adjacent symbols, causing the adjacent symbols to also act as wild cards. In one embodiment, the initially displayed symbols are visually replaced with the specially marked symbol. The gaming routine then determines the award to pay the player based upon the new symbol combination.

### EXAMPLE 2

In a modification to the example of FIG. 2, not all adjoining symbols are converted to the wild card when a specially marked symbol appears, but only symbols in certain positions are converted.

### EXAMPLE 3

In another embodiment, shown in FIG. 3, if a specially marked symbol appears, all symbols between the specially marked symbol and the leftmost symbol (an “a”) in a pay line (e.g., the horizontal pay line) containing the specially marked symbol are converted to the leftmost symbol. In FIG. 3, the specially marked symbol is displayed in the middle row of the fifth column. This is detected by the processor, and the processor converts all other symbols in the row to the leftmost symbol in the row. In the example of FIG. 3, the result is a win for five of the same symbols across a horizontal pay line. The specially marked symbol acts is a wild card. If the specially marked symbol were not in the rightmost position, a lesser award would be granted for fewer than five symbols across a horizontal pay line.

In another embodiment, symbols to the right of the specially marked symbol are converted to the same symbol as the rightmost symbol in the pay line. The same conversion to the leftmost or rightmost symbol may be performed for any pay line containing a specially marked symbol.

### EXAMPLE 4

FIG. 4 illustrates another example of the use of the specially marked symbol to change other symbols in a pay line. In FIG. 4, symbols along a bent pay line are shown. The initial display shows a specially marked symbol in the third column in the bottom row. The first and fifth reels in the first row display the same symbol. The occurance of the specially marked symbol causes the symbols along the diagonal arms of the bent pay line (i.e., the “b” and “c” symbols) to be replaced by the symbols (i.e., the “a” symbols) at the ends of the pay line. In the example of FIG. 4, since the symbols at the ends of the pay line are both “a,” the player is awarded for a five-symbol combination. This concept can, of course, be applied to any other pay line and can employ other criteria for converting symbols to other symbols or to the wild card symbol.

FIG. 5 illustrates the concept of FIG. 4 being applied to a different pay line, where symbols between the specially marked symbol and the ends of the pay line are converted to different symbols. In this case, the “b” and “e” symbols are converted to the “a” symbol, and an award for a five-symbol combination is paid.

### EXAMPLE 5

In another embodiment, shown in FIG. 6, if a specially marked symbol is displayed on any reel, a pseudo random number generator (e.g., the processor operating a random number program) selects one or more positions in the display matrix that are to become wild card symbols. The selected symbols are then changed to the wild card symbols. In FIG. 6, the upper, initial display shows the presence of a specially marked symbol in the second column, second row. In the lower, final display of FIG. 6, the symbol in the fourth column, first row, and the symbol in the fifth column, third row, have been randomly chosen for being replaced by the specially marked symbol, having the function of a wild card. The award to the player is then based on using these wild cards as the best possible symbol for any pay line passing through these positions.

### EXAMPLE 6

In a modification of the embodiment of FIG. 6, instead of converting randomly selected positions to specially marked symbols, one or more of the symbols in the initial display can be changed to higher value symbols. For example, the randomly selected positions in FIG. 6 (i.e., fourth column, first row; and fifth column, third row) can be changed to higher value symbols other than specially marked symbols. Such higher value symbols may be symbols that match other symbols on the pay line.

### EXAMPLE 7

In an alternative embodiment, certain symbols, other than the specially marked symbols, are previously designated as symbols which will have the wild card function only if a specially marked symbol is displayed somewhere in the symbol matrix. Accordingly, the presence of a specially marked symbol will convert these predetermined symbols to wild card symbols, and an award is then based upon the symbols being converted to the wild card symbols. These predetermined symbols may be initially selected by the player before the game is initiated, or the predetermined symbols may be fixed or selected by the processor.

### EXAMPLE 8

In an alternative embodiment, the occurrence of a specially marked symbol in the matrix converts all symbols on the pay lines passing through the position of the specially marked symbol to a particular symbol. The particular symbol may be fixed, or previously selected by the player, or selected by the processor.

Although the function of the specially marked symbol has been a wild card in the various examples given, the function of the specially marked symbol can be any function and may not be a wild card.

In another embodiment, the specially marked symbol is converted to another symbol. The conversion of symbols may be by any visual method or may simply be a non-visual change for awarding purposes. One suitable visual method of identifying the change in symbols may be a fading out of the initial symbol image and the fading in of the new symbol image.

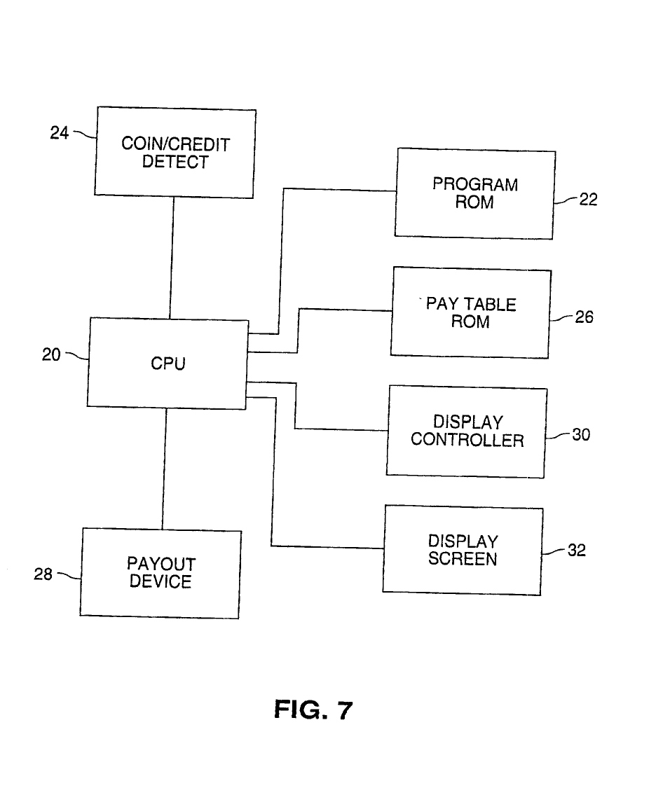

FIG. 7 illustrates basic circuit blocks in a suitable gaming device. A CPU 20 runs a gaming program stored in a program ROM 22. A coin/credit detector 24 enables the CPU 20 to initiate a next game. In one example, the gaming program receives various commands from the gaming device console and pseudo-randomly selects symbols to be displayed in a matrix. A paytable ROM 26 detects the various combinations of symbol across pay lines through the matrix and identifies awards to be paid to the player. A payout device 28 pays the award to the player in the form of credits or coins. A display controller 30 receives commands from the CPU 20 and generates signals for the display screen 32. If the display screen 32 is a touch screen, player commands may be input through the display screen into the CPU 20. The CPU carries out the basic steps used to change the symbols in accordance with the invention. One skilled in the art can write program code to implement the invention without undue experimentation.

Although the gaming device of FIG. 1 has been used as an example, the concepts of the various examples may be implemented in any type of apparatus used for gaming. Such an apparatus may include computers used for on-line gaming or gaming over any nework. Accordingly, various embodiments of a gaming device have been described wherein the occurrence of one or more specially marked symbols in a matrix effectively changes the appearance or effect of other symbols in the matrix to provide the player additional opportunities to win.

While particular embodiments have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

1. A gaming method comprising:
selecting a combination of symbols in a matrix of M rows and N columns, selected symbols including at least one special symbol and other symbols; and
converting at least one of said other symbols to at least one different symbol due to said at least one special symbol being selected for said matrix.

2. The method of claim 1 further comprising displaying said matrix.

3. The method of claim 2 further comprising converting displayed symbols in said matrix to different symbols due to said at least one special symbol being selected for said matrix.

4. The method of claim 1 wherein said selecting comprises operating a pseudo random number generator to identify symbols for said matrix.

5. The method of claim 1 further comprising providing an award for certain combinations of symbols across one or more pay lines.

6. The method of claim 1 where M equals 3 and N equals 5.

7. The method of claim 1 wherein said at least one special symbol is selected for a position in a row and column in said matrix, wherein said converting comprises converting symbols to the left of said special symbol in said row to another symbol.

8. The method of claim 7 wherein said converting comprises converting said symbols to the left of said special symbol to a symbol in the leftmost position of said row.

9. The method of claim 1 wherein said at least one special symbol is selected for a position in a row and column in said matrix, wherein said converting comprises converting symbols to the right of said special symbol in said row to another symbol.

10. The method of claim 9 wherein said converting comprises converting said symbols to the right of said special symbol to a symbol in the rightmost position of said row.

11. The method of claim 1 wherein said special symbol is selected for a position in a row and column in said matrix, and wherein said converting comprises converting symbols adjoining said special symbol to special symbols.

12. The method of claim 1 wherein said special symbol is selected for a position in a row and column in said matrix, and wherein said converting comprises converting symbols in certain positions in said matrix to other symbols.

13. The method of claim 1 wherein said converting comprises converting a visual image of initially selected symbols to a converted symbol.

14. The method of claim 1 wherein said special symbol is a wild card which represents a symbol of a highest value across a pay line.

15. The method of claim 1 further comprising determining, after said converting, whether symbols in said matrix include a winning combination of symbols by determining symbols across at least one pay line.

16. The method of claim 15 wherein said at least one pay line comprises horizontal pay lines.

17. The method of claim 16 wherein said at least one pay line further comprise bent pay lines.

18. The method of claim 1 wherein said converting comprises randomly selecting certain ones of said other symbols for conversion.

19. The method of claim 1 wherein said converting comprises converting certain ones of said other symbols to said special symbol.

20. The method of claim 1 wherein said converting comprises randomly selecting certain ones of said other symbols for conversion to said special symbol.

21. The method of claim 1 wherein said converting comprises converting at least one symbol on a pay line to another symbol on said pay line.

22. The method of claim 1 wherein said converting comprises converting said at least one special symbol to another symbol selected by a player.

23. The method of claim 1 wherein said converting comprises changing any symbols on a pay line to the left of a special symbol to a leftmost symbol on said pay line and converting any symbols on said pay line to the right of said special symbol to a rightmost symbol on said pay line.

24. A gaming device comprising:
a display device; and
control circuitry for controlling said display device, said control circuitry for controlling said display device to display a combination of selected symbols in a matrix of M rows and N columns, selected symbols in said matrix including at least one special symbol and other symbols, and for controlling said display device to convert at least one of said other symbols to at least one different symbol due to said at least one special symbol being selected for said matrix.

25. The device of claim 24 wherein said control circuitry controls said display device to convert displayed symbols in said matrix to different symbols due to said at least one special symbol being selected for said matrix.

26. The device of claim 24 wherein said control circuitry comprises a pseudo random number generator to identify symbols for said matrix.

27. The device of claim 24 further comprising a payout device for providing an award for certain combinations of symbols across one or more pay lines.

28. The device of claim 24 where M equals 3 and N equals 5.

29. The device of claim 24 wherein said at least one special symbol is selected for a position in a row and column in said matrix, wherein said control circuitry controls said display device to convert symbols to the left of said special symbol in said row to another symbol.

30. The device of claim 29 wherein said control circuitry controls said display device to convert said symbols to the left of said special symbol to a symbol in the leftmost position of said row.

31. The device of claim 24 wherein said at least one special symbol is selected for a position in a row and column in said matrix, wherein said control circuitry controls said display device to convert symbols to the right of said special symbol in said row to another symbol.

32. The device of claim 31 wherein said control circuitry controls said display device to convert said symbols to the right of said special symbol to a symbol in the rightmost position of said row.

33. The device of claim 24 wherein said special symbol is selected for a position in a row and column in said matrix, and wherein said control circuitry controls said display device to convert symbols adjoining said special symbol to special symbols.

34. The device of claim 24 wherein said special symbol is selected for a position in a row and column in said matrix, and wherein said control circuitry controls said display device to convert symbols in certain positions in said matrix to other symbols.

35. The device of claim 24 wherein said special symbol is a wild card which represents a symbol of a highest value across a pay line.

36. The device of claim 24 further comprising a payout table for determining, after conversion of said symbols, whether symbols in said matrix include a winning combination of symbols across at least one pay line.

37. The device of claim 36 wherein said at least one pay line comprises horizontal pay lines.

38. The device of claim 37 wherein said at least one pay line further comprise bent pay lines.

39. The device of claim 24 wherein said control circuitry comprises a pseudo-random number generator for randomly selecting certain ones of said other symbols for conversion.

40. The device of claim 24 wherein said control circuitry controls said display device to convert certain ones of said other symbols to said special symbol.

41. The device of claim 24 wherein said control circuitry comprises a pseudo-random number generator for randomly selecting certain ones of said other symbols for conversion to said special symbol.

42. The device of claim 24 wherein said control circuitry controls said display device to convert at least one symbol on a pay line to another symbol on said pay line.

43. The device of claim 24 wherein said control circuitry controls said display device to convert at least one special symbol to another symbol selected by a player.

44. The device of claim 24 wherein said control circuitry controls said display device to convert any symbols on a pay line to the left of a special symbol to a leftmost symbol on said pay line and convert any symbols on said pay line to the right of said special symbol to a rightmost symbol on said pay line.
